(19) United States
(12) Patent Application Publication
(10) Pub. No.: US 2002/0003834 A1
(43) Pub. Date: Jan. 10, 2002

(54) Rate adjustment technique in a CDMA receiver

(75) Inventor: Shinjiro Yoshimura, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION.

(21) Appl. No.: 09/866,556

(22) Filed: May 25, 2001

(30) Foreign Application Priority Data
May 25, 2000 (JP) 2000-155335

(51) Int. Cl. H04K 1/00; H04B 15/00; H04B 7/216; H04L 27/30

(52) U.S. Cl. 375/147; 370/342

(57) ABSTRACT

A rate adjustment device allowing the burden on a decoder to be reduced when decoding a variable-rate channel is disclosed. After despreadirg a received baseband signal based on a predetermined symbol rate to produce rate-indicating data and a sequence of received correlation values, a received symbol rate is compared to the maximum symbol rate and, when the received symbol rate is lower than the maximum symbol rate, it is determined whether a receive quality is satisfactory. When the receive quality is satisfactory, at least one received correlation value is selected from the received correlation values and is used to generate a correlation value matching the received symbol rate.

### BACKGROUND OF THE INVENTION

1. Field of the Invention

The present invention relates to a receiver for use in a variable rate CDMA (Code Division Multiple Access) communications system, and in particular to a rate adjustment method and device in a decoder of the receiver.

2. Description of the Related Art

In a variable rate CDMA communications system, one of a plurality of predetermined symbol rates is selected at a transmitting side and data is transmitted to a receiving side at the selected symbol rate. At the same time, the transmitting side sends rate decision data used to determine the selected symbol rate to the receiving side at a fixed rate. However, the selected symbol rate cannot be determined without decoding the rate decision data received from the transmitting side.

Accordingly, in general, a finger section or RAKE receiving section despreads a baseband received signal at the maximum symbol rate to produce correlation value data and then a decoder decodes the rate decision data to determine an actual symbol rate that has been selected at the transmitting side. If the actual symbol rate is lower than the despreading symbol rate that is now the maximum symbol rate, then the decoder performs rate adjustment of the correlation value data.

The rate adjustment is performed by adding correlation value data received from the finger section for a predetermined number of symbols. The rate adjustment like this is allowed in the case where a spreading code used for despreading is a code sequence such that a code pattern with a smaller spreading factor is repeated a predetermined number of times to form a code pattern with a larger spreading factor, such as OVSF (Orthogonal Variable Spreading Factor). An example of such a CDMA receiver is disclosed in Japanese Patent No. 2972694.

Hereafter, the rate adjustment by addition of correlation values will be described by referring to FIG. 1, taking as an example the case where a predetermined symbol rate is four times the actual symbol rate (here, the spreading factor SF of the finger section is 4 and that of the decoder is 16).

As shown in FIG. 1, the finger section performs despreading of the baseband received signal at the maximum symbol rate to produce correlation values in symbols. Since the predetermined symbol rate is four times as high as the actual symbol rate in this example, the decoder adds every four correlation values to produce a one-symbol correlation value. To avoid causing the sum of the four correlation values to exceed a predetermined upper limit of correlation value, the sum is normalized so that its maximum value falls within the upper limit. After the rate adjustment, the correlation value data is subject to framing, error-correction decoding, CRC checking, and so on.

However, according to the above-described rate adjustment method, the addition processing of correlation values is performed in the decoder, resulting in an increased burden on the decoder.

### SUMMARY OF THE INVENTION

An object of the present invention is to provide a rate adjustment method and device allowing the burden on the decoder to be reduced when decoding a variable-rate channel.

According to the present invention, a rate adjustment method in a receiver for use in a variable-rate CDMA (code division multiple access) communications system, includes the steps of: a) despreading a received baseband signal based on a predetermined symbol rate to produce at least rate-indicating data and a sequence of received correlation values; b) determining a received symbol rate of the received correlation values from the rate-indicating data; c) comparing the received symbol rate to the predetermined symbol rate; d) when the received symbol rate is lower than the predetermined symbol rate, comparing a receive quality to a predetermined quality level; e) when the receive quality is higher than the predetermined quality level, selecting at least one received correlation value from the received correlation values each corresponding to a number of symbols determined from a comparison result between the received symbol rate and the predetermined symbol rate; f) generating a correlation value matching the received symbol rate from at least one selected correlation value; and g) when the receive quality is not higher than the predetermined quality level, generating a correlation value matching the received symbol rate from the received correlation values.

The receive quality in the step (d) may be determined based on a SIR (signal to interference ratio) of the received baseband signal at the step (a). The receive quality in the step (d) may be determined based on an estimated BER (bit error rate) obtained by performing error-correction decoding of the correlation value matching the received symbol rate.

The variable-rate CDMA communications system may use a spreading code of OVSF (Orthogonal Variable spreading Factor) and the predetermined symbol rate is a maximum symbol rate of a receiving channel.

In the step (e), only one correlation value at a predetermined symbol timing may be selected from the received correlation values, and in the step (f), the correlation value matching the received symbol rate may be the selected correlation value.

In the step (e), a plurality of correlation values may be selected from the received correlation values, and in the step (f), the correlation value matching the received symbol rate may be generated by adding the selected plurality of correlation values.

In the step (g), the correlation value matching the received symbol rate may be generated by adding the received correlation values.

According to another aspect of the present invention, a rate adjustment device in a receiver for use in a variable-rate CDMA (code division multiple access) communications system, includes: a finger circuit for despreading a received baseband signal based on a predetermined symbol rate to produce at least rate-indicating data and a sequence of received correlation values; a rate determiner for determining a received symbol rate or the received correlation values from the rate-indicating data; a rate comparator or comparing the received symbol rate to the predetermined symbol rate; a quality comparator for comparing a receive quality to a predetermined quality level; a controllable adder for selectively adding the received correlation values to produce a correlation value matching the received symbol rate depending on a designation signal; and an addition controller for producing the designation signal instructing the controllable adder to add at least one received correlation value selected from the received correlation values each corresponding to a number of symbols determined from a comparison result of the rate comparator, when the received symbol rate is lower than the predetermined symbol rate and the receive quality is higher than the predetermined quality level.

As described above, when the receive quality is satisfactory, the correlation value addition operation can be simplified or removed from the rate adjusting operation, resulting in a reduced burden on the decoder 103.

### BRIEF DESCRIPTION OF THE DRAWINGS

FIG. 1 is a schematic diagram showing the addition processing of correlation values according to a conventional rate adjustment method;

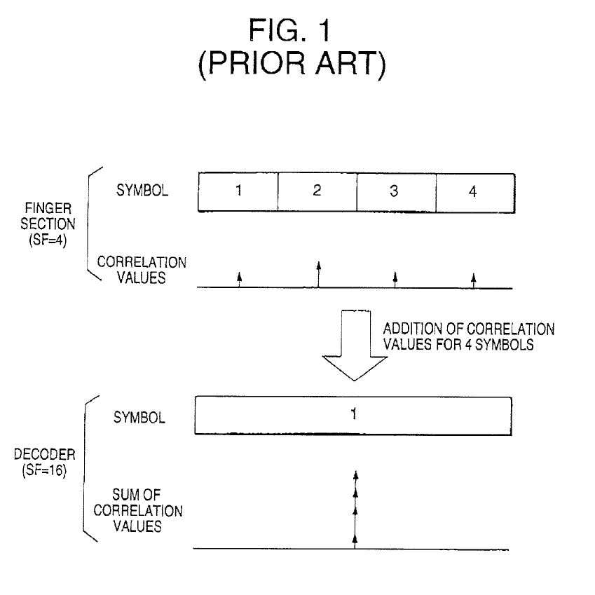

FIG. 2 is a block diagram showing the circuit configuration of a CDMA receiver according to a first embodiment of the present invention;

FIG. 3 is a flow chart showing an operation of a decoder in the first embodiment;

FIG. 4 is a schematic diagram showing an example of a rate adjusting operation according to the present invention;

FIG. 5 is a block diagram showing the circuit configuration of a CDMA receiver according to a second embodiment of the present invention.

### DESCRIPTION OF THE PREFERRED EMBODIMENTS

### First Embodiment

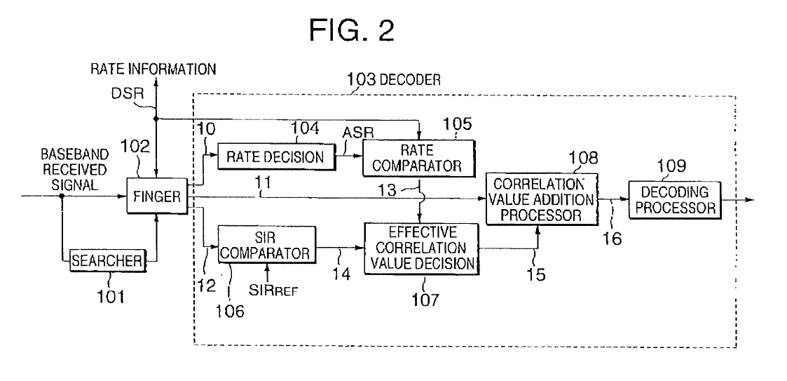

Referring to FIG. 2, a CDMA receiver according to a first embodiment of the present invention is provided with a demodulator (not shown), a searcher 101, a finger circuit 102, and a decoder 103. The demodulator demodulates a radio received signal to produce a baseband received signal, which is output to the searcher 101 and the finger circuit 102.

The searcher 101 searches the baseband received signal to find the receive timing of a significant path and outputs the found received timing to the finger circuit 102.

The finger circuit 102 is composed or a typical RAKE receiver structure, which performs despreading of the baseband received signal at the receive timing inputted from the searcher 101 using a despreading code determined based on rate information DSR (symbol rate or spreading factor). The rate information DSR is received from an upper layer and is set to the maximum one of possible symbol rates on a variable-rate channel. The finger circuit 102 produces rate decision data 10, correction value data 11 obtained by the RAKE combining process, and a SIR (Signal to Interference Ratio) value 12 of the received signal, which are output to the decoder 103.

In the decoder 103, a rate decision section 104 decodes the rate decision data 10 received from the finger circuit 102 to determine an actual symbol rate ASR of the received signal and output it to a rate comparator 105. The rate comparator 105 compares the rate information (here, the maximum symbol rate) DSR to the actual symbol rate ASR to output a rate comparison result 13 to an effective correlation value decision section 107.

The finger section 102 outputs the SIR value 12 of the received signal to a SIR comparator 106. The SIR comparator 106 compares the SIR value 12 of the received signal to a reference SIR value SIR_{REF} to output a SIR comparison result 14 to the effective correlation value decision section 107.

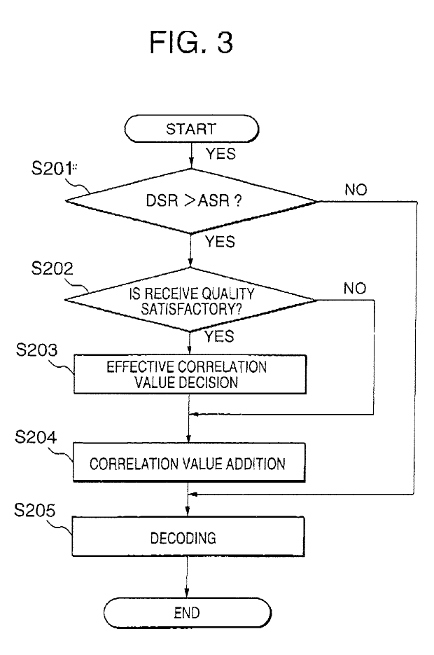

The effective correlation value decision section 107 produces an addition control signal 15 from the rate comparison result 13 and the SIR comparison result 14 according to a predetermined procedure. The addition control signal 15 is used to instruct the correlation value addition processor 108 whether the full addition, selective addition, or no addition of correlation values is performed, which will be described hereafter by referring to FIG. 3. The addition control signal 15 is output to a correlation value addition processor 108.

The correlation value addition processor 108 receives the correction value data 11 from the finger circuit 102 and performs addition of correlation values depending on the addition control signal 15. The correlation value addition processor 108 produce correlation value data 16, which is output to a decoding processor 109.

Rate Adjusting Operation

Hereafter, the full addition, selective addition, and no addition operations in the above decoder 103 will be described with reference to FIG. 3. The rate adjusting operation may be performed by a program-controlled processor running a rate adjustment program composed of the following steps thereon.

Referring to FIG. 3, the effective correlation value decision section 107 determines from the rate comparison result 13 whether the actual symbol rate ASR is lower than the predetermined symbol rate (here, the maximum symbol rate) DSR and how many times the predetermined symbol rate DSR is as high as the actual symbol rate ASR (step S201).

When ASR is equal to DSR (NO at stop S201), it is determined that no rate adjustment is necessary. Therefore, the effective correlation value decision section 107 produces the addition control signal 15 instructing the correlation value addition processor 108 to pass through the correction value data 11 to the decoding processor 109 (no addition operation). Accordingly, the correction value data 11 is decoded as it is by the decoding processor 109 (step S205). Since the predetermined symbol rate DSR is the maximum symbol rate, there is actually no case where ASR is higher than DSR at the step S201.

When the actual symbol rate ASR is lower than the predetermined symbol rate DSR (YES at step S201), the effective correlation value decision section 107 further determines from the SIR comparison result 14 whether the received signal SIR value is greater than the reference SIR value SIR_{REF}, that is, the receive quality is satisfactory (step S202).

If the received signal SIR value is not greater than the reference SIR value SIR_{REF} (NO at step S202), it is determined that the receiving quality is not sufficiently high. Therefore, the effective correlation value decision section 107 produces the addition control signal 15 instructing the correlation value addition processor 108 to perform the addition of correlation values for the predetermined number of symbols, which is the same as the prior art (full addition operation). Accordingly, the correlation value addition processor 108 performs the full addition operation and outputs who normalized sum as correction value data 16 to the decoding processor 109 (step S204). The correction value data 16 is decoded by the decoding processor 109 (step S205).

If the received signal SIR value is greater than the reference SIR value SIR_{REF} (YES at step S202), it is determined that the receiving quality is sufficiently high. Therefore, the effective correlation value decision section 107 produces the addition control signal 15 instructing the correlation value addition processor 108 to perform the addition of at least one selected from the correlation values for the predetermined number of symbols, which is called hereafter a selective addition operation (step S203). Accordingly, the correlation value addition processor 108 performs the selective addition operation and outputs the normalized sum as correction value data 16 to the decoding processor 109 (step S204). The correction value data 16 is decoded by the decoding processor 109 (step S205)

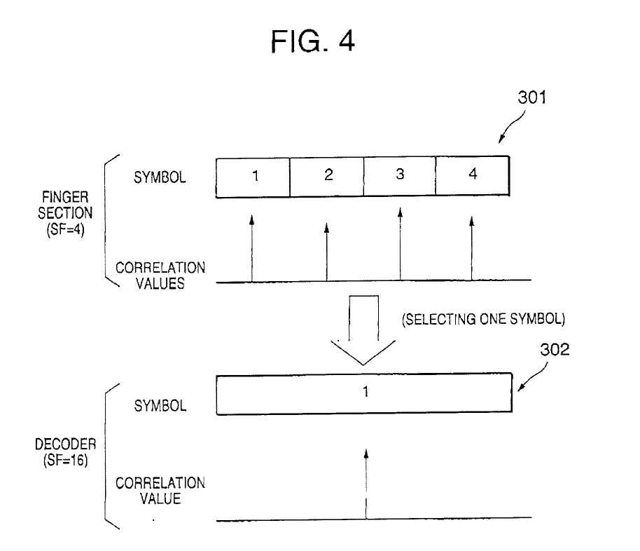

Hereafter, an example of the rate adjustment according to the first embodiment will be described by referring to FIG. 4, taking as an example the case where a predetermined symbol rate DSR (spreading factor: SF=4) is four times as high as the actual symbol rate ASR (SF=16) and the received signal SIR value is greater than the reference SIR value SIR_{REF}.

As shown in FIG. 4, the finger circuit 102 performs despreading of the baseband received signal at the maximum symbol rate DSR (SF−4) to produce correlation value data 301 in symbols. Since DSR is four times as high as ASR (YES at S201 of FIG. 3) and the received signal SIR>SIR_{REF} (YES at step S202 of FIG. 3), the effective correlation value decision section 107 selects one symbol 302 (here, the first symbol) from four symbols 301 and outputs the addition control signal 15 indicating the selected symbol timing to the correlation value addition processor 108.

Since only one symbol is selected from four symbols, the correlation value addition processor 108 transfers a correlation value corresponding to the selected symbol to the decoding processor 109 without the need of addition operation, resulting in a reduced amount of data to be processed in the decoder 103.

It is possible select two or three symbols from the four symbols. In this case, the amount of data to be processed in the decoder 103 is smaller than in the case of full addition of the four correlation values.

As described above, in the CDMA receiver according to the first embodiment of the present invention, when the receive quality is good, that is, the received signal SIR>SIR_{REF}, the correlation value addition operation can be omitted or simplified, resulting in a reduced burden on the decoder 103.

A received signal SIR is detected by the finger circuit 102 for each slot. Accordingly, the effective correlation value decision as described above can be performed at intervals of the slot. Alternatively, it can be performed at intervals of a longer time period by averaging received signal SIR values over a plurality of slots. In contrast, the correlation value addition is performed for each symbol. Therefore, by omitting or simplifying the correlation value addition operation, an amount of data to be processed in the decoder can be dramatically reduced as a whole.

As described above, the reference SIR value SIR_{REF} is used as a criterion to determine whether the correlation value addition operation can be omitted or simplified. Such a reference SIR value SIR_{REF} is determined by simulation or experiment so that desired receive quality can be obtained when omitting or simplifying the correlation value addition operation. The reference SIR value SIR_{REF} is stored in a memory (not shown) in the decoder 103.

### Second Embodiment

The receive quality can be determined by a receive-related value other than the received signal SIR value. For example, in some CDMA communications systems proposed by 3GPP (Third Generation Partnership Project), it is required that estimated BER (Bit Error Rate) is calculated at a receiving side and an upper layer is notified of the BER. More specifically, correlation value data after the rate adjustment process is subject to error-correction decoding and the decoded data is encoded again to produce re-encoded data. By comparing the re-encoded data to the correlation value data, estimated BER can be obtained. This estimated BER can be used as a criterion to determine whether the correlation value addition operation can be omitted or simplified. The details will be described hereafter.

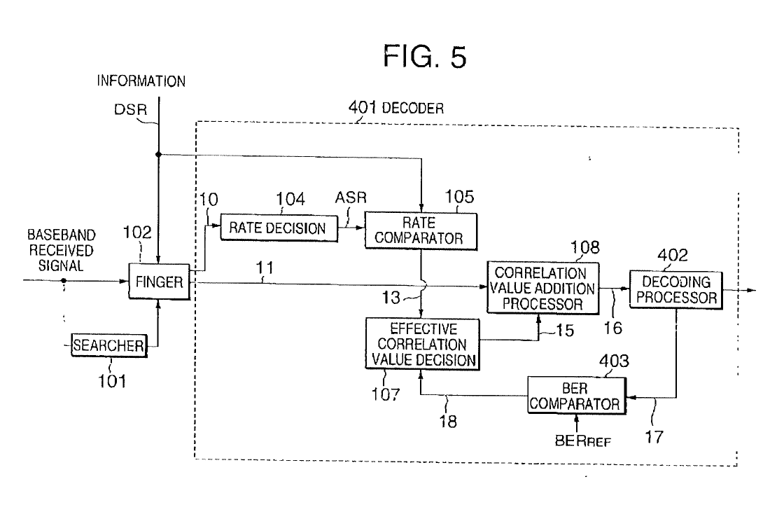

Referring to FIG. 5, a CDMA receiver according to a second embodiment of the present invention is provided with a decoder 401 that does not have the SIR comparator 106 of FIG. 2 but a decoding processor 402 having the BER estimation function and a BER comparator 403, where blocks similar to those previously described with reference to FIG. 2 are denoted by the same reference numerals and details thereof will be omitted.

The decoding processor 402 decodes the correction value data 16 inputted from the correlation value addition processor 108 according to the well-known error-correction coding scheme. The decoded data is encoded again and the re-encoded data is compared to the correlation value data 16 to produce an estimated BER value 17. The estimated BER value 17 is output to the BER comparator 403.

The BER comparator 403 compares the estimated BER value 17 to a reference BER value BER_{REF} to output a BER comparison result 18 to the effective correlation value decision section 107. The reference BER value BER_{REF} indicates the receive quality, which is determined depending on the type of service provided by a channel. The reference BER value BER_{REF} is stored in a memory (not shown) of the decoder 401.

The full addition, selective addition, and no addition operations in the decoder 401 are the same as those in the decoder 103 as shown in FIG. 3. A main part of the operations will be described briefly.

In FIG. 3, when ASR is equal to DSR (NO at step S201), it is determined that no rate adjustment is necessary. Therefore, the effective correlation value decision section 107 produces the addition control signal 15 instructing the correlation value addition processor 108 to pass through the correction value data 11 to the decoding processor 109 (no addition operation). Accordingly, the correction value data 11 is decoded as it is by the decoding processor 109 (step S205).

When the actual symbol rate ASR is lower than the predetermined symbol rate DSR (YES at step S201), the effective correlation value decision section 107 further determines from the BER comparison result 18 whether the estimated BER value is smaller than the reference BER value BER_{REF}, that is, the receive quality is satisfactory (step S202).

If the estimated BER value is not smaller than the reference BER value BER_{REF} (NO at step S202), it is determined that the receiving quality is not sufficiently high. Therefore, the effective correlation value decision section 107 produces the addition control signal 15 instructing the correlation value addition processor 108 to perform the addition of correlation values for a predetermined number of symbols, which is the same as the prior art (full addition operation). Accordingly, the correlation value addition processor 108 performs the full addition operation and outputs the normalized sum as correction value data 16 to the decoding processor 109 (step S204)

If the estimated BER value is smaller than the reference BER value BER_{REF} (YES at step S202), it is determined that the receiving quality is sufficiently high. Therefore, the effective correlation value decision section 107 produces the addition control signal 15 instructing the correlation value addition processor 108 to perform the addition of at least selected one of the correlation values for the predetermined number of symbols (selective addition) (step S203). Accordingly, the correlation value addition processor 108 performs the selective addition operation and outputs the normalized sum as correction value data 16 to the decoding processor 109 (step S204).

In this manner, in the CDMA receiver according to the second embodiment of the present invention, as the case of the first embodiment, when the receive quality is good, that is, the estimated BER<BER_{REF}, the correlation value addition operation can be omitted or simplified, resulting in a reduced burden on the decoder 401.

1. A rate adjustment method in a receiver for use in a variable-rate CDMA (code division multiple access) communications system, comprising the steps of;
a) despreading a received baseband signal based on a predetermined symbol rate to produce at least rate-indicating data and a sequence of received correlation values;
b) determining a received symbol rate of the received correlation values from the rate-indicating data;
c) comparing the received symbol rate to the predetermined symbol rate;
d) when the received symbol rate is lower than the predetermined symbol rate, comparing a receive quality to a predetermined quality level;
e) when the receive quality is higher than the predetermined quality level, selecting at least one received correlation value from the received correlation values each corresponding to a number of symbols determined from a comparison result between the received symbol rate and the predetermined symbol rate;
f) generating a correlation value matching the received symbol rate from at least one selected correlation value; and
g) when the receive quality is not higher than the predetermined quality level, generating a correlation value matching the received symbol rate from the received correlation values.

2. The rate adjustment method according to claim 1, wherein the receive quality in the step (d) is determined based on a SIR (signal to interference ratio) of the received baseband signal at the step (a).

3. The rate adjustment method according to claim 1, wherein the receive quality in the step (d) is determined based on an estimated BER (bit error rate) obtained by performing error-correction decoding of the correlation value matching the received symbol rate.

4. The rate adjustment method according to claim 1, wherein the variable-rate CDMA communications system uses a spreading code of OVSF (Orthogonal Variable spreading Factor) and the predetermined symbol rate is a maximum symbol rate of a receiving channel.

5. The rate adjustment method according to claim 1, wherein
in the step (e), only one correlation value at a predetermined symbol timing is selected from the received correlation values, and
in the step (f), the correlation value matching the received symbol rate is the selected correlation value.

6. The rate adjustment method according to claim 1, wherein
in the step (e), a plurality of correlation values are selected from the received correlation values, and
in the step (f), the correlation value matching the received symbol rate is generated by adding the selected plurality of correlation values.

7. The rate adjustment method according to claim 1, wherein
in the step (g), the correlation value matching the received symbol rate is generated by adding the received correlation values.

8. A rate adjustment device in a receiver for use in a variable-rate CDMA (code division multiple access) communication system, comprising:
a finger circuit for despreading a received baseband signal based on a predetermined symbol rate to produce at least rate-indicating data and a sequence of received correlation values;
a rate determiner for determining a received symbol rate of the received correlation values from the rate-indicating data;
a rate comparator for comparing the received symbol rate to the predetermined symbol rate;
a quality comparator for comparing a receive quality to a predetermined quality level;
a controllable adder for selectively adding the received correlation values to produce a correlation value matching the received symbol rate depending on a designation signal; and
an addition controller for producing the designation signal instructing the controllable adder to add at least one received correlation value selected from the received correlation values each corresponding to a number of symbols determined from a comparison result of the rate comparator, when the received symbol rate is lower than the predetermined symbol rate and the receive quality is higher than the predetermined quality level.

9. The rate adjustment device according to claim 8, wherein the finger circuit produces a SIR (signal to interference ratio) of the received baseband signal, wherein the quality comparator uses the SIR as the receive quality.

10. The rate adjustment method according to claim 8, further comprising:
a decoding processor performing error-correction decoding of output data of the controllable adder to produce an estimated BER (bit error rate) of the correlation value data,
wherein the quality comparator uses the estimated BER as the receive quality.

11. The rate adjustment device according to claim 8, wherein the variable-rate CDMA communications system uses a spreading code of OVSF (Orthogonal Variable spreading Factor) and the predetermined symbol rate is a maximum symbol rate of a receiving channel.

12. A receiver for use in a variable-rate CDMA (code division multiple access) communications system, comprising:
a searcher for searching for a receive timing of an effective path from a received baseband signal;
a finger circuit for despreading a received baseband signal according to the receive timing based on a maximum symbol rate of a receiving channel to produce rate-indicating data, a received SIR (signal to interference ratio) of the received baseband signal, and a sequence of received correlation values; and
a decoder for decoding the received correlation values to produce received data based on the rate-indicating data and the received SIR,
wherein the decoder comprises:
a rate determiner for determining a received symbol rate of the received correlation values from the rate-indicating data;
a rate comparator for comparing the received symbol rate to the maximum symbol rate;
a quality comparator for comparing the received SIR to a reference SIR;
a correlation value addition processor for selectively adding the received correlation values to produce a correlation value matching the received symbol rate depending on a designation signal;
an effective correlation value decision section for producing the designation signal instructing the correlation value addition processor to add at least one received correlation value selected from the received correlation values each corresponding to a number of symbols determined from a comparison result of the rate comparator, when the received symbol rate is lower than the maximum symbol rate and the received SIR is higher than the reference SIR; and
a decoding processor for decoding the correlation value matching the received symbol rate to produce the received data.

13. A receiver for use in a variable-rate CDMA (code division multiple access) communications system, comprising:
a searcher for searching for a receive timing of an effective path from a received baseband signal;
a finger circuit for despreading a received baseband signal according to the receive timing based on a maximum symbol rate of a receiving channel to produce rate-indicating data and a sequence of received correlation values; and
a decoder for decoding the received correlation values to produce received data based on the rate-indicating data and an estimated BER (bit error rate) obtained by performing error-correction decoding,
wherein the decoder comprises:
a rate determiner for determining a received symbol rate of the received correlation values from the rate-indicating data;
a rate comparator for comparing the received symbol rate to the maximum symbol rate;
a quality comparator for comparing the estimated BER to a reference BER;
a correlation value addition processor for selectively adding the received correlation values to produce a correlation value matching the received symbol rate depending on a designation signal;
an effective correlation value decision section for producing the designation signal instructing the correlation value addition processor to add at least one received correlation value selected from the received correlation values each corresponding to a number of symbols determined from a comparison result of the rate comparator, when the received symbol rate is lower than the maximum symbol rate and the estimated BER is lower than the reference BER; and
a decoding processor performing the error-correction decoding of output data of the correlation value addition processor to produce the received data and the estimated BER.
